(19) United States
(12) Patent Application Publication
(10) Pub. No.: US 2019/0096359 A1
(43) Pub. Date: Mar. 28, 2019

(54) DISPLAY CONTROL DEVICE, DISPLAY DEVICE, IN-VEHICLE DISPLAY SYSTEM, AND DISPLAY CONTROL METHOD

(71) Applicant: MITSUBISHI ELECTRIC CORPORATION, Tokyo (JP)

(72) Inventor: Masahiko UNO, Tokyo (JP)

(73) Assignee: MITSUBISHI ELECTRIC CORPORATION, Tokyo (JP)

(21) Appl. No.: 16/300,460

(22) PCT Filed: Jun. 9, 2016
(86) PCT No.: PCT/JP2016/067236

§ 371 Date: Nov. 9, 2018

(51) Int. Cl. G09G 5/00; G06F 3/01; G09G 5/10; G09G 5/02

(52) U.S. Cl. CPC G09G 5/003; G06F 3/013; G09G 5/10; G09G 5/02; G09G 2330/027; B60K 35/00; G09G 2354/00; G09G 2380/10; G09G 2320/08; G09G 2320/0606; G09G 2320/0626

(57) ABSTRACT

Included are: a gaze determining unit (102) for detecting the line of sight of an occupant on the basis of information acquired by a detected information acquiring unit (101) and, in a case where the detected line of sight of the occupant is located within a preset range, determining that the occupant is gazing ahead of the vehicle; and a display control unit (104) for performing display control of image information by using a display setting which suppresses the image information to be displayed for the occupant from being reflected on a preset area in a case where it is determined that the occupant is gazing ahead of the vehicle.

### TECHNICAL FIELD

The present invention relates to technology for displaying image information on an in-vehicle display.

### BACKGROUND ART

When a vehicle is travelling with an in-vehicle display turned on at night, there are cases where a display screen of the in-vehicle display is reflected on the windshield or the side windows of the vehicle, thereby interfering with an occupant's field of view. In these cases, techniques for reducing the luminance of the in-vehicle display when the occupant is not viewing the in-vehicle display to suppress or prevent the display screen of the in-vehicle display from being reflected on the windshield or the side windows have been proposed.

For example, Patent Literature 1 discloses an information display device for determining whether the face of a driver is directed toward an in-vehicle display on the basis of a captured image of the face of the driver supplied from a camera mounted on the in-vehicle display. This information display device turns on the in-vehicle display to display image information when the face of the driver is directed toward the in-vehicle display, and turns off the in-vehicle display to prevent image information from being displayed when the face of the driver is not directed toward the display and route guidance is not provided.

### CITATION LIST

### PATENT LITERATURE

Patent Literature 1: JP 2008-292753 A

### SUMMARY OF INVENTION

### Technical Problem

The area of an in-vehicle display is generally small, and thus the problem with the technique described in Patent Literature 1 is that the configuration of the device becomes complicated since various types of processing are required in order to correctly determine whether the face of the driver is directed toward the in-vehicle display, that is, whether the driver is viewing the in-vehicle display. Furthermore, in the technique described in Patent Literature 1, the in-vehicle display is turned on to display image information when the face of the driver is directed toward the in-vehicle display. Thus, the problem with this technique is that it is impossible to perform control to surely display an image on the in-vehicle display when the driver is about to view the in-vehicle display. An example of such control is to detect that the driver is about to view the in-vehicle display from a change in the driver's viewing state and increase the luminance of the in-vehicle display as preparation.

The present invention has been made to solve the problems as described above, and it is an object of the present invention to detect whether an occupant is viewing an in-vehicle display with a simple configuration and to perform control to promptly display image information on the in-vehicle display depending on the detected viewing state of the occupant.

### Solution to Problem

A display control device according to the present invention includes: a detected information acquiring unit for acquiring information resulting from detection of an occupant onboard a vehicle; a gaze determining unit for detecting a line of sight of the occupant on the basis of the information acquired by the detected information acquiring unit and, in a case where the detected line of sight of the occupant is located within a preset range, determining that the occupant is gazing ahead of the vehicle; and a display control unit for referring to a determination result acquired by the gaze determining unit and, in a case where it is determined that the occupant is gazing ahead of the vehicle, performing display control of image information by using a display setting which suppresses the image information to be displayed for the occupant from being reflected on a preset area.

### Advantageous Effects of Invention

According to the present invention, it is possible to detect whether an occupant is viewing an in-vehicle display with a simple configuration. It is also possible to perform control to promptly display image information on the in-vehicle display depending on a detected viewing state of the occupant for the in-vehicle display.

### BRIEF DESCRIPTION OF DRAWINGS

FIG. 1 is a block diagram illustrating a configuration of a display control device according to a first embodiment.

FIGS. 2A and 2B are diagrams each illustrating a hardware configuration of the display control device according to the first embodiment.

FIG. 3 is a flowchart illustrating operation of the display control device according to the first embodiment.

FIG. 4 is a flowchart illustrating operation of a display control unit of the display control device according to the first embodiment.

FIG. 5 is a block diagram illustrating a configuration of a display control device according to a second embodiment.

FIG. 6 is a flowchart illustrating operation of the display control device according to the second embodiment.

FIG. 7 is a flowchart illustrating other operation of the display control device according to the second embodiment.

FIG. 8 is a block diagram illustrating a configuration of an in-vehicle display system having the function of the display control device according to the first embodiment.

### DESCRIPTION OF EMBODIMENTS

To describe the present invention further in detail, embodiments for carrying out the present invention will be described below with reference to the accompanying drawings.

### First Embodiment

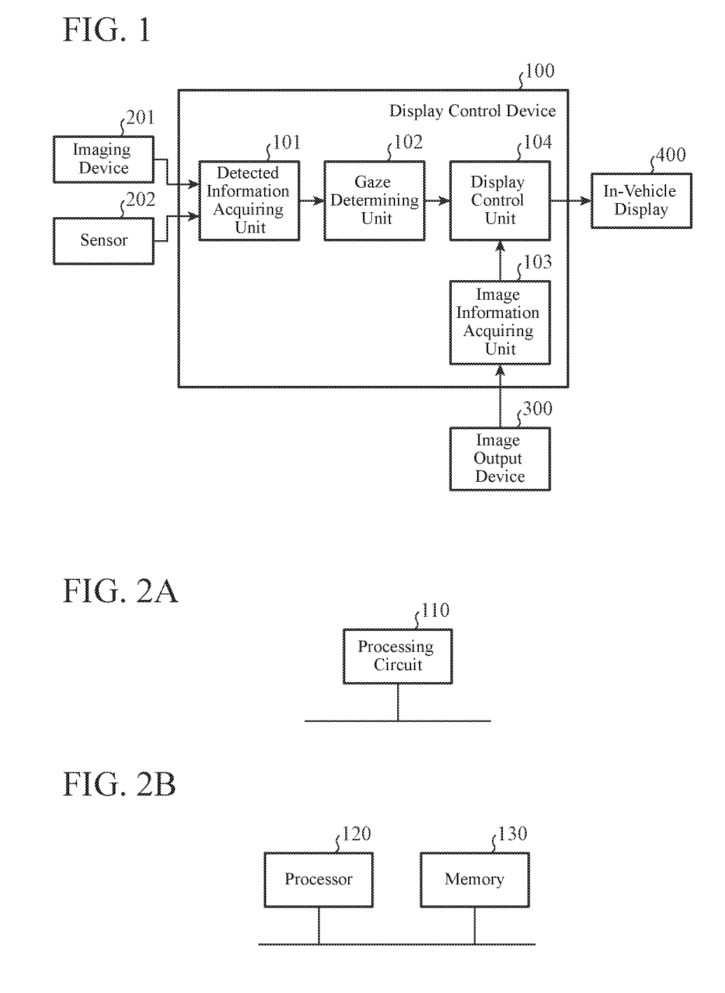

FIG. 1 is a block diagram illustrating a configuration of a display control device according to a first embodiment.

A display control device 100 includes a detected information acquiring unit 101, a gaze determining unit 102, an image information acquiring unit 103, and a display control unit 104.

Furthermore, the display control device 100 is mounted to a vehicle and connected to at least one of an imaging device 201 and a sensor 202 that are installed in the interior of the vehicle, an image output device 300 installed in the vehicle interior, and an in-vehicle display 400 installed in the vehicle interior.

The imaging device 201 includes, for example, a camera (a visible light camera, an infrared light camera, etc.). The imaging device 201 is installed in the vehicle interior so that the detection range thereof includes a driver's seat and acquires an image capturing an area including the face of a driver (occupant) seated in the driver's seat. The image captured by the imaging device 201 is input to the detected information acquiring unit 101.

The sensor 202 includes various sensors such as a range sensor (an infrared ray sensor, a laser sensor, etc.) or an ultrasonic sensor. In the case where the sensor 202 includes a range sensor, the sensor 202 is installed in the vehicle interior so that the detection range thereof includes the driver's seat and acquires a ranging result obtained by ranging an area including the face or the head of a driver seated in the driver seat. The detection result acquired by the sensor 202 is input to the detected information acquiring unit 101.

The detected information acquiring unit 101 acquires information input from at least one of the imaging device 201 and the sensor 202 at all times.

The gaze determining unit 102 analyzes the information acquired by the detected information acquiring unit 101 and detects the line of sight of the driver. When the gaze determining unit 102 analyzes the captured image, the gaze determining unit 102 first recognizes the face of the driver by detecting the driver's eyes, nose, mouth, etc. from the captured image, and detects the line of sight of the driver from the position of the eye, nose, mouth, etc. of the driver and direction of the face of the driver. Here, the line of sight of the driver refers to a line segment connecting a point that serves as the reference such as the position of the eye of the driver and a point that the driver is looking at. The gaze determining unit 102 determines whether the driver gazes ahead of the vehicle from the detected line of sight of the driver.

Meanwhile, in a case where the gaze determining unit 102 analyzes a ranging result, the gaze determining unit 102 first detects the position of the head of the driver from the ranging result and estimates the position of the driver's viewpoint from the detected position of the head. The gaze determining unit 102 detects the line of sight of the driver from the estimated position of the viewpoint and the direction of the head. The gaze determining unit 102 determines whether the driver gazes ahead of the vehicle from the detected line of sight of the driver.

The gaze determining unit 102 determines whether the driver gazes ahead of the vehicle on the basis of whether the detected line of sight of the driver satisfies preset conditions. Details of the preset conditions used for the determination by the gaze determining unit 102 will be described later.

The image information acquiring unit 103 acquires image information output from the image output device 300 at all times.

The display control unit 104 performs display control to cause the in-vehicle display 400 to display the image information acquired by the image information acquiring unit 103. The display control unit 104 further controls display settings of the in-vehicle display 400 on the basis of the determination result acquired by the gaze determining unit 102. In a case where the gaze determining unit 102 determines that the driver is gazing ahead of the vehicle, the display control unit 104 performs display control on the in-vehicle display 400 by using a display setting which suppresses a display screen of the in-vehicle display 400 from being reflected on a preset area such as the windshield and side windows of the vehicle. The preset areas are not limited to the aforementioned windshield and side windows, and can be appropriately changed.

Here, the display setting which suppresses a display screen of the in-vehicle display 400 from being reflected on the preset area may be to reduce the luminance of the in-vehicle display 400, to turn off the in-vehicle display 400, to turn off only a backlight of the in-vehicle display 400, to display a black screen on the in-vehicle display 400, to display a screen with a dark color tone matching the interior of the vehicle on the in-vehicle display 400, or the like.

On the other hand, in a case where the gaze determining unit 102 determines that the driver is not gazing ahead of the vehicle, the display control unit 104 performs display control on the in-vehicle display 400 by using a preset display setting (hereinafter referred to as a “preset display setting”) such as initial setting values of the in-vehicle display 400.

The image output device 300 includes, for example, a head unit that provides image information to the display control device 100.

The in-vehicle display 400 is a display device installed in the vehicle interior such as a center display and an instrument cluster. Note that the in-vehicle display 400 is not limited to these display devices, and any display device can be used as long as the display device is mounted on the vehicle.

Next, an exemplary hardware configuration of the display control device 100 will be described.

FIGS. 2A and 2B are diagrams illustrating exemplary hardware configurations of the display control device 100 according to the first embodiment.

The detected information acquiring unit 101, the gaze determining unit 102, the image information acquiring unit 103, and the display control unit 104 in the display control device 100 may be a processing circuit 110 that is dedicated hardware as illustrated in FIG. 2A, or may be a processor 120 that executes a program stored in a memory 130 as illustrated in FIG. 2B.

As illustrated in FIG. 2A, in the case where the detected information acquiring unit 101, the gaze determining unit 102, the image information acquiring unit 103, and the display control unit 104 correspond to dedicated hardware, the processing circuit 110 corresponds to, for example, a single circuit, a composite circuit, a programmed processor, a parallel programmed processor, an application specific integrated circuit (ASIC), a field-programmable gate array (FPGA), or a combination thereof. A function of each of the detected information acquiring unit 101, the gaze determining unit 102, the image information acquiring unit 103, and the display control unit 104 may be separately implemented by a processing circuit, or the functions of the respective units may collectively implemented by one processing circuit.

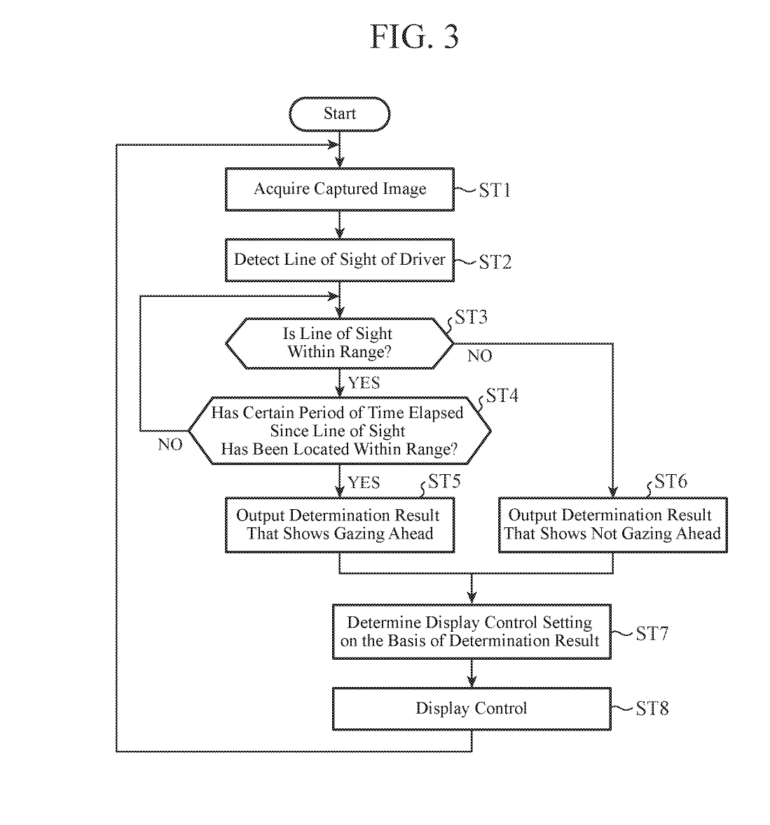

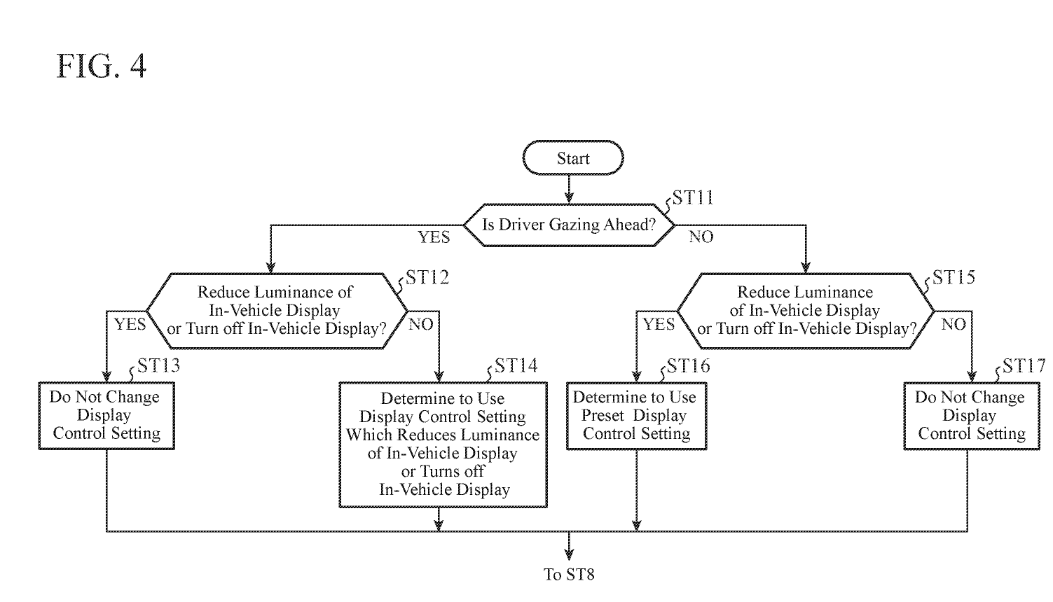

As illustrated in FIG. 2B, in a case where the detected information acquiring unit 101, the gaze determining unit 102, the image information acquiring unit 103, and the display control unit 104 correspond to the processor 120, the function of each of the units is implemented by software, firmware, or a combination of software and firmware. Software and firmware are described as a program and stored in the memory 130. The processor 120 implements the functions of the detected information acquiring unit 101, the gaze determining unit 102, the image information acquiring unit 103, and the display control unit 104 by reading out and executing a program stored in the memory 130. That is, the detected information acquiring unit 101, the gaze determining unit 102, the image information acquiring unit 103, and the display control unit 104 have the memory 130 for storing programs execution of which by the processor 120 results in execution of steps illustrated in FIGS. 3 and 4, which will be described later. It can also be said that these programs cause a computer to execute procedures or methods of the detected information acquiring unit 101, the gaze determining unit 102, the image information acquiring unit 103, and the display control unit 104.

Here, the processor 120 corresponds to, for example, a central processing unit (CPU), a processing device, an arithmetic device, a processor, a microprocessor, a microcomputer, a digital signal processor (DSP), or the like.

The memory 130 may be a non-volatile or volatile semiconductor memory such as a random access memory (RAM), a read only memory (ROM), a flash memory, an erasable programmable ROM (EPROM), or an electrically EPROM (EEPROM), a magnetic disk such as a hard disk or a flexible disk, or an optical disk such as a mini disk, a compact disc (CD) or a digital versatile disc (DVD).

Note that a part of the functions of the detected information acquiring unit 101, the gaze determining unit 102, the image information acquiring unit 103, and the display control unit 104 may be implemented by dedicated hardware, and another part thereof may be implemented by software or firmware. In this manner, the processing circuit 110 in the display control device 100 can implement the above functions by hardware, software, firmware, or a combination thereof.

Next, operation of the display control device 100 will be described.

FIG. 3 is a flowchart illustrating the operation of the display control device 100 according to the first embodiment.

Note that in the following description, a case where a captured image is input from the imaging device 201 to the display control device 100 will be described as an example. It is also assumed that captured images are constantly input from the imaging device 201 to the detected information acquiring unit 101.

The gaze determining unit 102 acquires a captured image from the detected information acquiring unit 101 (step ST1). The gaze determining unit 102 analyzes the captured image acquired in step ST1 and detects the line of sight of the driver (step ST2). The gaze determining unit 102 determines whether the line of sight of the driver detected in step ST2 is located within a preset range (step ST3). Here, the preset range is a range in which it is presumed that the driver is viewing ahead of the vehicle, which is for example a range where the windshield and the side windows are arranged. In this case, in the determination of step ST3, the gaze determining unit 102 determines that the line of sight of the driver is located within the preset range in the case where the line of sight of the driver is located within the range where the windshield or the side windows are arranged.

In the case where the line of sight of the driver is located within the preset range (step ST3: YES), the gaze determining unit 102 further determines whether a certain period of time (e.g. one second, a few seconds, etc.) has elapsed since the line of sight of the driver has been located within the range (step ST4). If the certain period of time has not elapsed since the line of sight of the driver has been located within the preset range (step ST4: NO), the process returns to step ST3. On the other hand, if the certain period of time has elapsed since the line of sight of the driver has been located within the preset range (step ST4: YES), the gaze determining unit 102 outputs a determination result that shows that the driver is gazing ahead of the vehicle to the display control unit 104 (step ST5).

On the other hand, if the line of sight of the driver is not located within the preset range (step ST3: NO), the gaze determining unit 102 outputs a determination result that shows that the driver is not gazing ahead of the vehicle to the display control unit 104 (step ST6). The display control unit 104 determines a display control setting for image information on the basis of the determination result output in step ST5 or step ST6 (step ST7). The display control unit 104 performs display control to display the image information acquired by the image information acquiring unit 103 on the in-vehicle display 400 by using the display control setting determined in step ST7 (step ST8), and the process returns to step ST1.

Note that in the flowchart of FIG. 3 described above, the case where a captured image is input from the imaging device 201 has been described as an example; however, also in a case where information input from the sensor 202 illustrated in the block diagram of FIG. 1 is used, likewise, whether the driver is gazing ahead of the vehicle can be determined by detection of the line of sight of the driver by the gaze determining unit 102 and determination as to whether the detected line of sight of the driver is located within the preset range and as to whether the certain period of time has elapsed since the detected line of sight of the driver has been located within the preset range.

Next, details of the processing of the display control unit 104 described in step ST7 of the flowchart of FIG. 3 will be described with reference to a flowchart of FIG. 4.

FIG. 4 is a flowchart illustrating the operation of the display control unit 104 of the display control device 100 according to the first embodiment. Note that in FIG. 4, a case is described as an example where a setting which reduces the luminance of the in-vehicle display 400 or turns off the in-vehicle display 400 is applied as a display setting which suppresses a display screen of the in-vehicle display 400 from being reflected on the preset area.

The display control unit 104 determines whether the driver is gazing ahead of the vehicle by referring to the determination result output in step ST5 or step ST6 (step ST11). If the driver is gazing ahead of the vehicle (step ST11: YES), the display control unit 104 determines whether display control to reduce the luminance of the in-vehicle display 400 or display control to turn off the in-vehicle display 400 has been performed already (step ST12).

If the display control to reduce the luminance of the in-vehicle display 400 or the display control to turn off the in-vehicle display 400 has been performed already (step ST12: YES), the display control unit 104 determines not to change the display control setting of the in-vehicle display 400 but to maintain the current display control setting (step ST13). On the other hand, if neither the display control to reduce the luminance of the in-vehicle display 400 nor the display control to turn off the in-vehicle display 400 has been performed (step ST12: NO), the display control unit 104 determines to use a display control setting which reduces the luminance of the in-vehicle display 400 or turns off the in-vehicle display 400 (step ST14).

Contrarily, if the driver is not gazing ahead of the vehicle (step ST11: NO), the display control unit 104 determines whether the display control to reduce the luminance of the in-vehicle display 400 or the display control to turn off the in-vehicle display 400 is currently performed (step ST15). If the display control to reduce the luminance of the in-vehicle display 400 or the display control to turn off the in-vehicle display 400 is currently performed (step ST15: YES), the display control unit 104 determines the preset display setting as a display control setting to be used (step ST16). On the other hand, if neither the display control to reduce the luminance of the in-vehicle display 400 nor the display control to turn off the in-vehicle display 400 is performed (step ST15: NO), the display control unit 104 determines not to change the display control setting of the in-vehicle display 400 but to maintain the current display control setting (step ST17).

When processing of any one of steps ST13, ST14, ST16, and step ST17 is performed, the process proceeds to step ST8 in the flowchart of FIG. 3.

In the above description of the flowchart of FIG. 4, the case where the display control unit 104 performs the display control to reduce the luminance of the in-vehicle display 400 or turn off the in-vehicle display 400 has been described as an example. In addition to this example of display control, the display control unit 104 may perform display control such as to turn off only a backlight of the in-vehicle display 400, to display a black screen on the in-vehicle display 400, or to display a screen with a dark color tone matching the interior of the vehicle on the in-vehicle display 400. Apart from the aforementioned types of display control, any display screen that can prevent the display screen of the in-vehicle display 400 from being reflected on a windshield or a side window of a vehicle may be applicable as appropriate.

In the case where the display control unit 104 performs the display control to turn off the in-vehicle display 400, this contributes to suppression of the electric power consumed by the in-vehicle display 400. However, in such case, there are cases where it takes time to restart the in-vehicle display 400 or the luminance of the in-vehicle display 400 is not stable upon starting up.

Reducing the luminance of the in-vehicle display 400, turning off the backlight, or displaying a black screen or a screen with a dark color tone by the display control unit 104 makes it possible to smoothly switch between displaying state and non-displaying state of the in-vehicle display 400 and to stably maintain the luminance of the in-vehicle display 400. As a result, reflection of the display screen of the in-vehicle display 400 on the windshield or the side windows can be prevented appropriately, and furthermore in a case where the driver wishes to view the in-vehicle display 400, recovery to the display screen displaying image information can be smoothly performed.

As described above, included according to the first embodiment are: the detected information acquiring unit 101 for acquiring information resulting from detection of an occupant onboard a vehicle; the gaze determining unit 102 for detecting the line of sight of the occupant on the basis of the information acquired by the detected information acquiring unit 101 and, in a case where the detected line of sight of the occupant is located within a preset range, determining that the occupant is gazing ahead of the vehicle; and the display control unit 104 for referring to a determination result acquired by the gaze determining unit 102 and, in a case where it is determined that the occupant is gazing ahead of the vehicle, performing display control of the image information by using a display setting which suppresses the image information to be displayed for the occupant from being reflected on a preset area. Therefore, it is possible to determine whether the occupant is viewing the in-vehicle display on the basis of whether the line of sight of the occupant is located within the preset range of a wide area such as the windshield and the side windows without determining whether the occupant is viewing the in-vehicle display having a small area. As a result, a viewing state of the occupant can be detected with a simple configuration.

Furthermore, it is possible to perform control to surely display an image on the in-vehicle display when the occupant intends to view the in-vehicle display, such as to raise the luminance of the in-vehicle display as preparation when the occupant is not gazing ahead. As a result, it is possible to perform control to promptly display image information on the in-vehicle display depending on a viewing state of the occupant for the in-vehicle display.

Furthermore, according to the first embodiment, the gaze determining unit 102 determines that the occupant is gazing ahead of the vehicle when the line of sight of the occupant is directed toward the windshield or a side window of the vehicle. Therefore, it is possible to appropriately suppress reflection on the windshield or the side windows which affects occupant's driving, depending on a viewing state of the occupant.

Furthermore, according to the first embodiment, the display control unit 104 performs display control on the in-vehicle display 400 by using a display setting which reduces the display luminance of the in-vehicle display 400, turns off the in-vehicle display 400, displays a screen with a dark color tone on the in-vehicle display 400, or turns off the backlight of the in-vehicle display 400 when the gaze determining unit 102 determines that the occupant is gazing ahead of the vehicle. Therefore, it is possible to suppress the power consumption of the in-vehicle display or to smoothly switch between on and off of the in-vehicle display.

### Second Embodiment

In a second embodiment, whether to execute gaze determination processing by a gaze determining unit 102 is determined depending on a traveling state of a vehicle or user's selection.

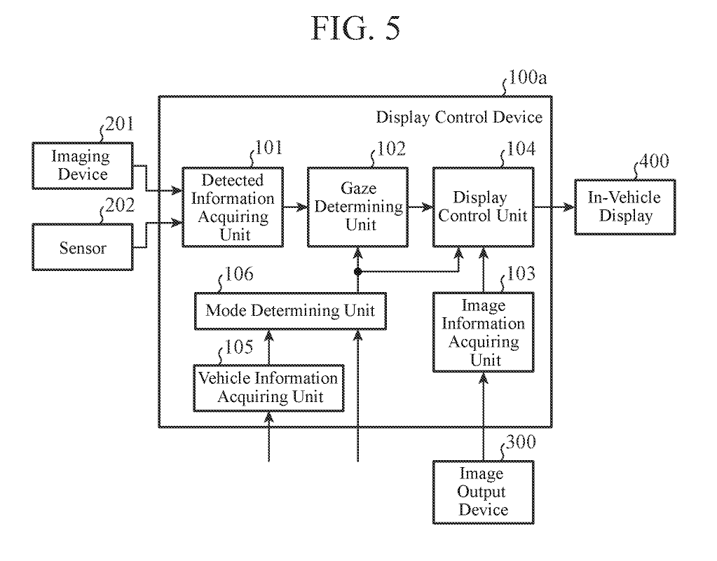

FIG. 5 is a block diagram illustrating a configuration of a display control device 100a according to the second embodiment.

The display control device 100a according to the second embodiment is configured by adding a vehicle information acquiring unit 105 and a mode determining unit 106 to the display control device 100 described in the first embodiment.

In the following description, the same symbol as that used in the first embodiment is provided to the same component as or an equivalent component to that of the display control device 100 according to the first embodiment, and description thereof is omitted or simplified.

The vehicle information acquiring unit 105 acquires information indicating a traveling state of the vehicle, such as the speed of the vehicle or information on the state of the parking brake, via an in-vehicle network or other means (not illustrated).

The mode determining unit 106 refers to the information indicating the traveling state of the vehicle acquired by the vehicle information acquiring unit 105 and, in a case where the vehicle speed is “0” or the parking brake is ON, determines that the vehicle is stopped or parked. In the case where the mode determining unit 106 determines that the vehicle is stopped or parked, the mode determining unit 106 instructs a display control unit 104 to perform display on an in-vehicle display 400 by using a preset display setting. On the other hand, in the case where the mode determining unit 106 determines that the vehicle is neither stopped nor parked, the mode determining unit 106 instructs the gaze determining unit 102 to execute gaze determination processing.

In addition to referring to the information indicating the traveling state of the vehicle, the mode determining unit 106 may determine whether to execute the gaze determination processing on the basis of user input that is input via an operation input device such as a touch panel (not illustrated). When the mode determining unit 106 accepts user input for selecting a mode for turning on the in-vehicle display 400 at all times, the mode determining unit 106 instructs the display control unit 104 to perform display on the in-vehicle display 400 by using the preset display setting. Note that the mode determining unit 106 may be configured to accept user input for selecting a mode for turning off the in-vehicle display 400 at all times.

On the other hand, when the mode determining unit 106 accepts user input for selecting a mode for suppressing reflection on the windshield and the side windows, the mode determining unit 106 instructs the gaze determining unit 102 to execute gaze determination processing.

Next, an exemplary hardware configuration of the display control device 100a will be described. Note that drawings illustrating hardware configuration examples of the display control device 100a of the second embodiment are the same as FIG. 2A and FIG. 2B illustrated in the first embodiment, and thus illustration thereof is omitted. In addition, description of the same component as that of the first embodiment is also omitted.

The vehicle information acquiring unit 105 and the mode determining unit 106 in the display control device 100a may be a processing circuit 110 that is dedicated hardware as illustrated in FIG. 2A, or may be a processor 120 that executes a program stored in a memory 130 as illustrated in FIG. 2B.

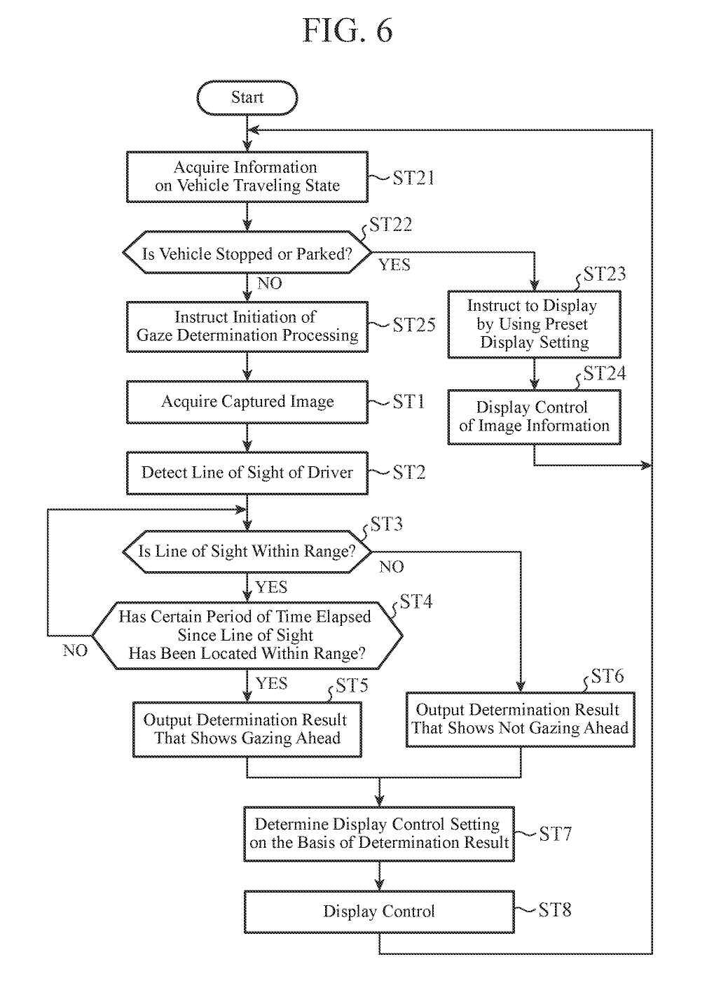

Moreover, as illustrated in FIG. 2B, in a case where the vehicle information acquiring unit 105 and the mode determining unit 106 correspond to the processor 120, the functions of the vehicle information acquiring unit 105 and the mode determining unit 106 are implemented by software, firmware, or a combination of software and firmware. Software and firmware are described as a program and stored in the memory 130. The processor 120 reads and executes the program stored in the memory 130 and thereby implements the functions of the vehicle information acquiring unit 105 and the mode determining unit 106. That is, the vehicle information acquiring unit 105 and the mode determining unit 106 have the memory 130 for storing programs execution of which by the processor 120 results in execution of steps illustrated in FIG. 6, which will be described later. It can also be said that these programs cause a computer to execute procedures or methods of the vehicle information acquiring unit 105 and the mode determining unit 106.

Note that a part of the functions of the vehicle information acquiring unit 105 and the mode determining unit 106 may be implemented by dedicated hardware, and another part thereof may be implemented by software or firmware. In this manner, the processing circuit 110 in the display control device 100a can implement the above functions by hardware, software, firmware, or a combination thereof.

Next, operation of the display control device 100a will be described.

FIG. 6 is a flowchart illustrating the operation of the display control device 100a according to the second embodiment. In FIG. 6, the same step as that in the flowchart of the first embodiment described in FIG. 3 is denoted by the same symbol, and description thereof will be omitted. In FIG. 6, illustrated is the case where the mode determining unit 106 determines whether to execute the gaze determination processing on the basis of the information indicating the traveling state of the vehicle acquired by the vehicle information acquiring unit 105.

The vehicle information acquiring unit 105 acquires information indicating the traveling state of the vehicle (step ST21). The mode determining unit 106 determines whether the vehicle is stopped or parked by referring to the information indicating the traveling state of the vehicle acquired in step ST21 (step ST22). If the vehicle is stopped or parked (step ST22: YES), the mode determining unit 106 instructs the display control unit 104 to display image information by using the preset display setting (step ST23). The display control unit 104 performs display control to display the image information acquired by an image information acquiring unit 103 on the in-vehicle display 400 on the basis of the instruction input in step ST23 (step ST24), and the process returns to step ST21.

On the other hand, when the vehicle is neither stopped nor parked (step ST22: NO), that is, when the vehicle is traveling, the mode determining unit 106 instructs the gaze determining unit 102 to initiate the gaze determination processing (step ST25). Thereafter, the process proceeds to step ST1.

Next, operation in the case where the mode determining unit 106 determines whether to execute the gaze determination processing on the basis of user input will be described.

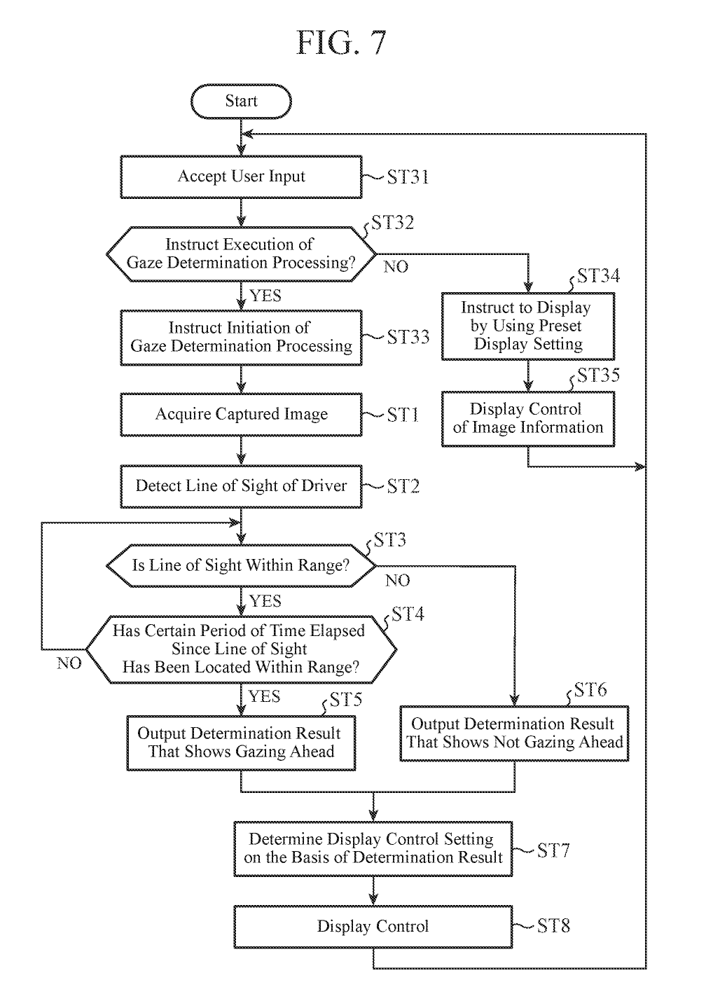

FIG. 7 is a flowchart illustrating other operation of the display control device 100a according to the second embodiment. In FIG. 7, the same step as that in the flowchart of the first embodiment described in FIG. 3 is denoted by the same symbol, and description thereof will be omitted.

When accepting user input (step ST31), the mode determining unit 106 determines whether the user input is instructing execution of the gaze determination processing (step ST32). If the user input is instructing execution of the gaze determination processing (step ST32: YES), the mode determining unit 106 instructs the gaze determining unit 102 to initiate the gaze determination processing (step ST33). Thereafter, the process proceeds to step ST1.

On the other hand, if the user input is not instructing execution of the gaze determination processing (step ST32: NO), the mode determining unit 106 instructs the display control unit 104 to display image information by using the preset display setting (step ST34). The display control unit 104 performs display control to display the image information acquired by the image information acquiring unit 103 on the in-vehicle display 400 on the basis of the instruction input in step ST34 (step ST35), and the process returns to step ST31.

As described above, according to the second embodiment, included is the mode determining unit 106 for determining, on the basis of a traveling state of the vehicle or input by an occupant of the vehicle, whether to perform the determination of whether the occupant is gazing ahead of the vehicle. Therefore, it is possible to switch between control by using a display setting which suppresses reflection of the image information and control by using the preset display setting, on the basis of the traveling state of the vehicle or the input by the occupant of the vehicle.

Furthermore according to the second embodiment, the mode determining unit 106 instructs the gaze determining unit 102 to detect the line of sight of the occupant when the vehicle is neither stopped nor parked or when the occupant has performed selection which means that control to suppress reflection of the image information is necessary. Therefore, it is possible to suppress reflection of the image information by performing the gaze determination processing only when it is necessary to suppress the reflection of the image information.

Note that in the first and second embodiments described above, the case where the gaze determining unit 102 performs the gaze determination processing by using the line of sight of the driver has been illustrated as an example; however, the occupant is not limited to a driver. For example, the display control unit 104 may perform display control with the gaze determining unit 102 using the line of sight of an occupant seated in the passenger seat.

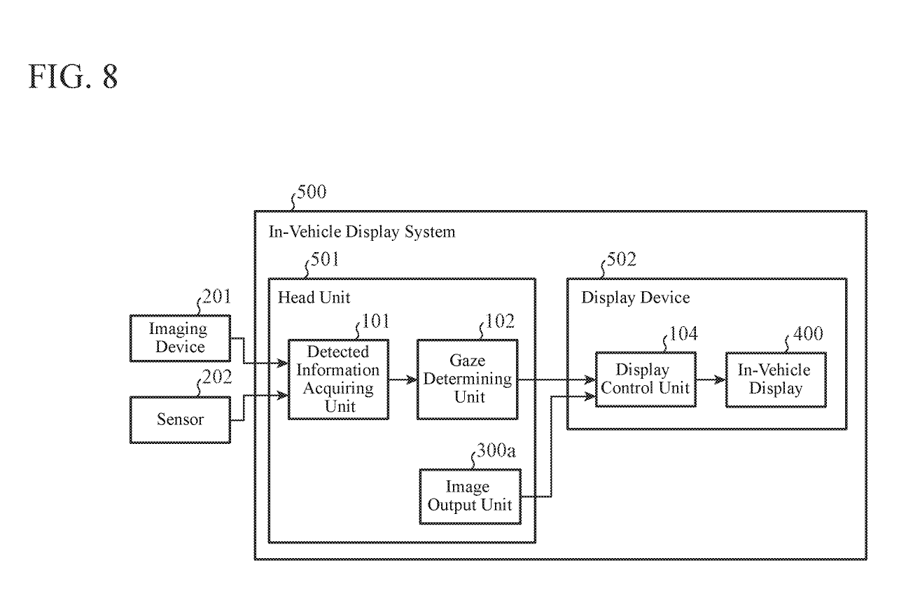

In the first and second embodiments described above, the configuration in which each of the display control devices 100 and 100a includes the gaze determining unit 102 has been described; however, an in-vehicle display system 500 as illustrated in FIG. 8 may be also configured.

FIG. 8 is a block diagram illustrating a configuration of the in-vehicle display system 500 having the function of the display control device 100 according to the first embodiment.

The in-vehicle display system 500 illustrated in FIG. 8 includes a head unit (image output device) 501 and a display device 502. The head unit 501 is a device that outputs image information, and includes an image information output unit 300a. The image information output unit 300a is equivalent to the image output device 300 illustrated in FIG. 1. The head unit 501 further includes a detected information acquiring unit 101 and a gaze determining unit 102. The head unit 501 is often mounted with a high-performance CPU, and thus the head unit 501 is suitable as a component for performing processing of information input from an imaging device 201 or a sensor 202. With the gaze determining unit 102 executing the gaze determination processing in the head unit 501, the configuration of the display device 502 can be simplified, and thus the display device 502 is implemented at low costs.

The display device 502 includes a display control unit 104 and an in-vehicle display 400 and displays image information on the in-vehicle display 400 using a determination result of the gaze determination processing and the image information input from the head unit 501.

Note that the case where the in-vehicle display system 500 is configured by the components of the display control device 100 illustrated in the first embodiment has been illustrated in FIG. 8 as an example; however, an in-vehicle display system may be configured by the components of the display control device 100a illustrated in the second embodiment. In this case, the vehicle information acquiring unit 105 and the mode determining unit 106 are included in the head unit 501.

In addition to the above, the present invention may include a flexible combination of the respective embodiments, a modification of any component of the respective embodiments, or omission of any component in the respective embodiments within the scope of the present invention.

### INDUSTRIAL APPLICABILITY

The display control device according to the present invention is capable of suppressing reflection of image information which interferes with an occupant's field of view, and thus is applicable to display of image information on an in-vehicle display mounted on a vehicle to improve visibility of the occupant when the vehicle is driven.

### Reference Signs List

100, 100a: Display control device, 101: Detected information acquiring unit, 102: Gaze determining unit, 103: Image information acquiring unit, 104: Display control unit, 105: Vehicle information acquiring unit, 106: Mode determining unit, 201: Imaging device, 202: Sensor, 300: Image output device, 300a: Image output unit, 400: In-vehicle display, 500: In-vehicle display system, 501: Head unit, 502: Display device

1-8. (canceled)

9. A display control device comprising:
a processor to execute a program; and
a memory to store the program which, when executed by the processor, performs processes of,
acquiring information resulting from detection of an occupant onboard a vehicle;
detecting a line of sight of the occupant on a basis of the information acquired and, in a case where the detected line of sight of the occupant is located within a preset range, determining that the occupant is gazing ahead of the vehicle; and
referring to a determination result acquired and, in a case where it is determined that the occupant is gazing ahead of the vehicle, performing display control of image information by using a display setting which suppresses the image information to be displayed for the occupant from being reflected on a preset area.

10. The display control device according to claim 9, wherein the processes further include determining that the occupant is gazing ahead of the vehicle when the line of sight of the occupant is directed toward a windshield or a side window of the vehicle.

11. The display control device according to claim 9, wherein the processes further include, in the case where it is determined that the occupant is gazing ahead of the vehicle, performing the display control of the image information by using a display setting which reduces display luminance of an in-vehicle display mounted on the vehicle, turns off the in-vehicle display, displays a screen with a dark color tone on the in-vehicle display, or turns off a backlight of the in-vehicle display.

12. The display control device according to claim 9, wherein the processes further include determining, on a basis of a travelling state of the vehicle or input by the occupant, whether to perform determination of whether the occupant is gazing ahead of the vehicle.

13. The display control device according to claim 12, wherein the processes further include detecting the line of sight of the occupant when the vehicle is neither stopped nor parked, or in a case where the occupant has performed input to select display for suppressing reflection of the image information.

14. A display device comprising:
the display control device according to claim 9; and
an in-vehicle display to display the image information on a basis of display control by the display control device.

15. An in-vehicle display system, comprising:
an image output device comprising:
a processor to execute a program; and
a memory to store the program which, when executed by the processor, performs processes of,
acquiring information resulting from detection of an occupant onboard a vehicle;
detecting a line of sight of the occupant on a basis of the information acquired and, in a case where the detected line of sight of the occupant is located within a preset range, determining that the occupant is gazing ahead of the vehicle; and
outputting image information to be displayed for the occupant; and
a display device comprising:
a processor to execute a program;
a memory to store the program which, when executed by the processor, performs processes of,
referring to a determination result acquired by the image output device and, in a case where it is determined that the occupant is gazing ahead of the vehicle, performing display control of the image information by using a display setting which suppresses a display of the image information from being reflected on a preset area; and
an in-vehicle display to display the image information on a basis of the display control.

16. A display control method comprising:
acquiring information resulting from detection of an occupant onboard a vehicle;
detecting a line of sight of the occupant on a basis of the acquired information and, in a case where the detected line of sight of the occupant is located within a preset range, determining that the occupant is gazing ahead of the vehicle; and
referring to a result of the determination and, in a case where it is determined that the occupant is gazing ahead of the vehicle, performing display control of image information by using a display setting which suppresses the image information to be displayed for the occupant from being reflected on a preset area.
